(19) United States
(12) Patent Application Publication
(10) Pub. No.: US 2016/0226094 A1
(43) Pub. Date: Aug. 4, 2016

(54) ELECTRODE COMPOSITE BODY, METHOD OF MANUFACTURING ELECTRODE COMPOSITE BODY, AND BATTERY

(71) Applicant: SEIKO EPSON CORPORATION, Tokyo (JP)

(72) Inventor: Yasushi YAMAZAKI, Azumino-shi (JP)

(73) Assignee: SEIKO EPSON CORPORATION, Tokyo (JP)

(21) Appl. No.: 15/007,765

(22) Filed: Jan. 27, 2016

(30) Foreign Application Priority Data
Jan. 30, 2015 (JP) 2015-016563

(51) Int. Cl. H01M 10/0525; H01M 4/04; H01M 4/131; H01M 4/1391; H01M 10/0562; H01M 10/0565

(52) U.S. Cl. CPC H01M 10/0525; H01M 10/0562; H01M 10/0565; H01M 4/131; H01M 4/1391; H01M 4/0407; H01M 4/045

(57) ABSTRACT

An electrode composite body includes a composite body which includes an active material molded body that is constituted by a porous body in which a plurality of active material particles are three-dimensionally connected to each other, and which has a communication hole, a solid electrolyte layer which is formed on a surface, which includes a surface of the communication hole of the active material molded body, of the active material molded body, and includes granular bodies (solid electrolyte particles) containing a solid electrolyte, and an electron conduction layer which covers at least a part of one of the active material molded body and the solid electrolyte layer in the communication hole, and has electron conductivity, and a current collector that is provided on one surface of the composite body to be joined to the active material molded body.

### BACKGROUND

This application claims a priority to Japanese Patent Application No. 2015-016563 filed on Jan. 30, 2015 which is hereby expressly incorporated by reference in its entirety.

### BACKGROUND

1. Technical Field

Several aspects of the present invention relate to an electrode composite body, a method of manufacturing the electrode composite body, and a battery.

2. Related Art

As a power supply of a lot of electrical apparatuses including as a portable information apparatus, a battery such as a lithium battery (including a primary battery and a secondary battery) has been used. The lithium battery includes a positive electrode, a negative electrode, and an electrolyte layer that is provided between layers of the positive electrode and the negative electrode and mediates lithium ion conduction therebetween.

Recently, as a lithium battery in which a high energy density and stability are compatible with each other, there is suggested an all-solid type lithium battery that uses a solid electrolyte in a formation material of the electrolyte layer (for example, refer to JP-A-2006-277997, JP-A-2004-179158, and Japanese Patent No. 4615339).

The all-solid type lithium battery is demanded to have a high output and a high capacity in a stable manner over a long period of time, but it cannot be said that these characteristics are sufficiently obtained in the all-solid type lithium battery of the related art.

### SUMMARY

An advantage of some aspects of the invention is to provide an electrode composite body capable of realizing a battery that stably maintains a high output and a high capacity over a long period of time when being applied to the battery, a method of manufacturing the electrode composite body, and a battery that includes the electrode composite body, and is capable of stably maintaining the high output and the high capacity over a long period of time.

The advantage can be accomplished by the invention described below.

An electrode composite body according to an aspect of the invention includes: a composite body including an active material molded body constituted by a porous body in which a plurality of active material particles having a particle shape are three-dimensionally connected to each other and which has a communication hole, a solid electrolyte layer that is formed on a surface, which includes a surface of the communication hole of the active material molded body, of the active material molded body, and includes solid-electrolyte-containing solid electrolyte particles having a particle shape, and an electron conduction layer which covers at least a part of one of the active material molded body and the solid electrolyte layer in the communication hole, and has electron conductivity; and a current collector that is provided on one surface of the composite body to be joined to the active material molded body.

When the electrode composite body including the active material molded body configured as described above is applied to a battery, the battery can stably maintain a high output and a high capacity over a long period of time.

In the electrode composite body according to the aspect of the invention, it is preferable that electron conductivity of the electron conduction layer is higher than electron conductivity of the active material molded body.

According to this configuration, it is possible to allow the electron conduction layer to reliably exhibit a function as an electron conduction path, and thus it is possible to reliably lower internal resistance in the composite body.

In the electrode composite body according to the aspect of the invention, it is preferable that the electron conduction layer covers a part of both the active material molded body and the solid electrolyte layer.

According to this configuration, the electron conduction layer is formed between adjacent active material particles which constitute the active material molded body, between adjacent granular bodies which constitute the solid electrolyte layer, or between the active material particle and the granular body which are adjacent to each other. As a result, the electron conduction path obtained by the electron conduction layer is formed in a network shape, and thus it is possible to reliably lower the internal resistance in the composite body.

In the electrode composite body according to the aspect of the invention, it is preferable that the electron conduction layer selectively covers a part of the active material molded body between the active material molded body and the solid electrolyte layer.

According to this configuration, the electron conduction layer is formed between the active material particles adjacent to each other. As a result, the electron conduction path obtained by the electron conduction layer is formed in a network shape, and thus it is possible to reliably lower the internal resistance in the composite body.

In the electrode composite body according to the aspect of the invention, it is preferable that the electron conduction layer is at least one kind of a carbon-containing coat layer and a metal layer.

According to this configuration, it is possible to allow the electron conduction layer to exhibit excellent electron conductivity.

In the electrode composite body according to the aspect of the invention, it is preferable that in the composite body, both the active material molded body and the solid electrolyte layer are exposed from the one surface, and the solid electrolyte layer is exposed alone from the other surface.

According to this configuration, in a battery to which the electrode composite body is applied, it is possible to prevent an electrode and the current collector from being connected through the active material molded body, that is, it is possible to prevent short-circuiting.

A method of manufacturing an electrode composite body according to another aspect of the invention includes: heating active material particles having a particle shape to connect a plurality of the active material particles to each other, thereby obtaining an active material molded body that is constituted by a porous body including a communication hole; applying a liquid substance including a precursor of a solid electrolyte to a surface, which includes a surface inside the communication hole of the active material molded body, of the active material molded body, and heating the liquid substance to form a solid electrolyte layer; forming an electron conduction layer having electron conductivity so as to cover at least one of the active material molded body and the solid electrolyte layer to form a composite body; and joining a current collector to the one surface of the composite body to come into contact with the active material molded body.

When the electrode composite body, which is manufactured as described above, is applied to a battery, the battery can stably maintain the high output and the high capacity for a long period of time.

In the method of manufacturing an electrode composite body according to the aspect of the invention, it is preferable that in the formation of the composite body, a metal layer, which selectively covers a part of the active material molded body between the active material molded body and the solid electrolyte layer, is formed as the electron conduction layer by using an electrolytic plating method.

According to the electrolytic plating method, it is possible to easily form the metal layer configured as described above as the electron conduction layer.

In the method of manufacturing an electrode composite body according to the aspect of the invention, it is preferable that in the formation of the composite body, a carbon-containing coat layer, which covers a part of both the active material molded body and the solid electrolyte layer, is formed as the electron conduction layer by using a sol-gel method.

According to the sol-gel method, it is possible to easily form the carbon-containing coat layer configured as described above as the electron conduction layer.

A battery according to still another aspect of the invention includes the electrode composite body according to the aspect of the invention, and an electrode that is provided on the other surface of the composite body to be joined to the solid electrolyte layer.

When including the electrode composite body provided with the active material molded body configured as described above, the battery can stably maintain the high output and the high capacity over a long period of time.

### BRIEF DESCRIPTION OF THE DRAWINGS

The invention will be described with reference to the accompanying drawings, wherein like numbers reference like elements.

FIG. 1 is a longitudinal cross-sectional view illustrating a first embodiment in which a battery according to the invention is applied to a lithium secondary battery.

FIGS. 2A and 2B are views illustrating a method of manufacturing the lithium secondary battery illustrated in FIG. 1.

FIGS. 3A and 3B are views illustrating the method of manufacturing the lithium secondary battery illustrated in FIG. 1.

FIGS. 4A and 4B are views illustrating the method of manufacturing the lithium secondary battery illustrated in FIG. 1.

FIGS. 5A to 5C are views illustrating the method of manufacturing the lithium secondary battery illustrated in FIG. 1.

FIG. 6 is a view illustrating the method of manufacturing the lithium secondary battery illustrated in FIG. 1.

FIG. 7 is a longitudinal cross-sectional view illustrating a second embodiment in which the battery according to the invention is applied to the lithium secondary battery.

FIG. 8 is a longitudinal cross-sectional view illustrating a third embodiment in which the battery according to the invention is applied to the lithium secondary battery.

FIG. 9 is a longitudinal cross-sectional view illustrating a fourth embodiment in which the battery according to the invention is applied to the lithium secondary battery.

### DESCRIPTION OF EXEMPLARY EMBODIMENTS

Hereinafter, an electrode composite body, a method of manufacturing the electrode composite body, and a battery according to the invention will be described in detail on the basis of embodiments illustrated in the accompanying drawings.

In addition, in the following description, first, a lithium secondary battery to which the battery according to the invention is applied will be described.

### Lithium Secondary Battery

### First Embodiment

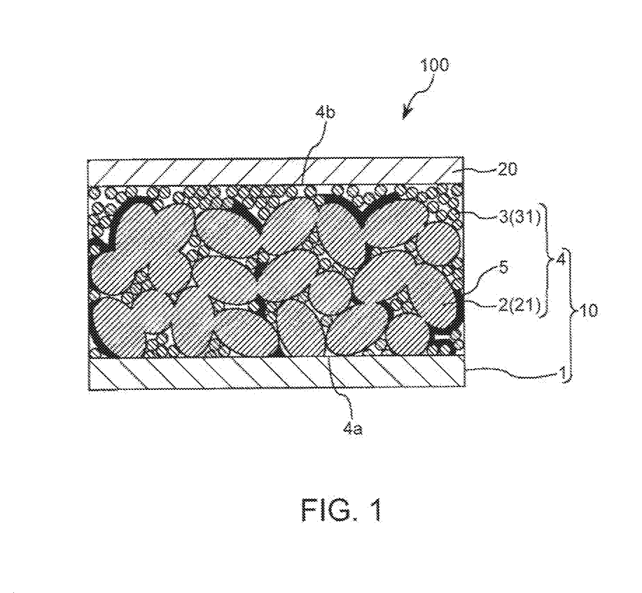

FIG. 1 is a longitudinal cross-sectional view illustrating a first embodiment in which the battery according to the invention is applied to the lithium secondary battery. In addition, in the following description, an upper side and a lower side in FIG. 1 are referred to as “upper” and “lower” for convenience of explanation. In addition, in FIG. 1, dimensions, ratios, and the like of respective constituent elements are appropriately made different for easy understanding of the drawings.

A lithium secondary battery 100 includes an electrode composite body 10, and an electrode 20 that is jointed onto the electrode composite body 10. The lithium secondary battery 100 is a so-called all-solid type lithium (ion) secondary battery.

As illustrated in FIG. 1, the electrode composite body (electrode composite body according to the invention) 10 includes a current collector 1, an active material molded body 2, a solid electrolyte layer 3, and an electron conduction layer 5. In addition, in the following description, a configuration obtained by combining the active material molded body 2, the solid electrolyte layer 3, and the electron conduction layer 5 will be referred to as a composite body 4. The composite body 4 is positioned between the current collector 1 and an electrode 20, and comes into contact with the current collector 1 and the electrode 20 on a pair of surfaces 4a and 4b which are opposite to each other.

The current collector 1 is an electrode for extraction of a current that is generated through a battery reaction, and is provided to come into contact with the solid electrolyte layer 3, the active material molded body 2 and the electron conduction layer 5, which are exposed from the solid electrolyte layer 3, on one surface (on one side) 4a of the composite body 4.

In a case where the active material molded body 2 to be described later is composed of a positive electrode active material, the current collector 1 functions as a positive electrode, and in a case where the active material molded body 2 is composed of a negative electrode active material, the active material molded body 2 functions as a negative electrode.

In addition, examples of a formation material (constituent material) of the current collector 1 include one kind of metal (elementary metal substance) that is selected from the group consisting of copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and palladium (Pd), an alloy including two or more kinds of metal element selected from the group, and the like.

The shape of the current collector 1 is not particularly limited, and examples thereof include a sheet shape, a foil shape, a network shape, and the like. In addition, the surface of the current collector 1 may be flat or uneven.

As illustrated in FIG. 1, the active material molded body 2 includes an active material particle 21 which includes a lithium composite oxide, and has a particle shape, and is a porous molded body that is formed in such a manner that a plurality of the active material particles 21 are three-dimensionally connected.

A plurality of pores formed in the active material molded body 2, which is the porous molded body, form communication holes which communicate with each other in a network shape at the inside of the active material molded body 2. That is, the active material molded body 2 is constituted by a porous body that includes a void that is constituted by the communication holes.

The active material particles 21 have a particle shape and constitute the active material molded body 2. The plurality of active material particles 21 are connected to each other to form a porous body.

The active material particles 21 contain an inorganic electrode active material including a lithium composite oxide as a formation material (constituent material), and the current collector 1 may be a positive electrode or a negative electrode through appropriate selection of a kind of the formation material.

In a case where the current collector 1 is set as the positive electrode, with regard to the formation material of the active material molded body 2, for example, a known lithium composite oxide can be used as a positive electrode active material.

In addition, the “lithium composite oxide” in this specification represents an oxide which essentially includes lithium, and includes two or more kinds of metal ions as a whole, and in which existence of oxo acid ions is not recognized.

Examples of the lithium composite oxide include LiCoO₂, LiNiO₂, LiMn₂O₄, Li₂Mn₂O₃, LiFePO₄, Li₂FeP₂O₇, LiMnPO₄, LiFeBO₃, LiV₂(PO₄)₂, Li₂CuO₂, LiFeF₃, Li₂FeSiO₄, Li₃MnSiO₄, and the like. In addition, in this specification, a solid-solution, in which a part of atoms in a crystal of the lithium composite oxide is substituted with other transition metals, typical metals, alkali metals, alkali rare-earth elements, lanthanoids, chalcogenides, halogens, and the like, is included to the lithium composite oxide, and this solid-solution can also be used as the positive electrode active material.

In addition, in a case where the current collector 1 is set as the negative electrode, with regard to the formation material of the active material molded body 2, for example, a lithium composite oxide such as Li₄Ti₅O₁₂ and Li₂Ti₃O₇, or a material such as Si, SiO, and Sn that is capable of intercalating lithium ions can be used as the negative electrode active material.

When including the lithium composite oxide, delivery of an electron is performed between the plurality active material particles 21, and delivery of lithium ions is performed between the active material particles 21 and the solid electrolyte layer 3, and thus the active material particles 21 exhibit a function as the active material molded body 2.

An average particle size of the active material particles 21 is preferably 300 nm to 5 μm, more preferably 450 nm to 3 μm, and still more preferably 500 nm to 1 μm. When using the active material having the average particle size, it is possible to set a porosity of the active material molded body 2 in a range described to be later. According to this, a surface area of pores in the active material molded body 2 increases, and it is easy to increase a contact area between the active material molded body 2 and the solid electrolyte layer 3. Accordingly, it is easy to allow the lithium secondary battery using the electrode composite body 10 to have a high capacity.

In addition, when the average particle size of the active material particles 21 is less than the lower limit, the radius of the pores which are formed in the active material molded body is likely to be as small as several nm depending on a kind of a liquid substance to be described later, and it is difficult to impregnate the inside of the pores with the liquid substance, which includes a precursor of an inorganic solid electrolyte, in the method of manufacturing the lithium secondary battery to be described later. As a result, there is a concern that it is difficult to form the solid electrolyte layer 3 that comes into contact with a surface inside the pores, or the electron conduction layer 5 that is formed after formation of the solid electrolyte layer 3.

In addition, when the average particle size of the active material particles 21 is greater than the upper limit, a specific surface area, which is a surface area per unit mass, of the active material molded body 2 that is formed decreases, and thus a contact area between the active material molded body 2 and the solid electrolyte layer 3 decreases. According to this, there is a concern that a sufficient output may not be obtained in the lithium secondary battery 100. In addition, an ion diffusion distance from the inside of the active material particles 21 to the solid electrolyte layer 3 is lengthened, and thus there is a concern that it is difficult for the lithium composite oxide in the vicinity of the center of the active material particles 21 to contribute the function of the battery.

In addition, for example, the average particle size of the active material particles 21 can be measured by obtaining a median diameter by using a light-scattering type particle size distribution measuring device (nano track UPA-EX250, manufactured by Nikkiso Co., Ltd.) after dispersing the active material particles 21 in n-octanol to have a concentration in a range of 0.1% by mass to 10% by mass.

In the active material molded body 2, which is constituted by a porous body formed in a state in which the plurality of active material particles 21 are three-dimensionally connected, the porosity is preferably 10% to 50%, and more preferably 30% to 50%. When the active material molded body 2 has the porosity, the surface area inside the pores of the active material molded body 2 increases, and it is easy to increase the contact area between the active material molded body 2 and the solid electrolyte layer 3, or the contact area between the active material molded body and the electron conduction layer. As a result, it is easy to allow the lithium secondary battery using the electrode composite body 10 to have a high capacity.

For example, the porosity can be measured from (1) a volume (apparent volume) of the active material molded body 2 including the pores which is obtained from external dimensions of the active material molded body 2, (2) a mass of the active material molded body 2, and (3) a density of an active material that constitutes the active material molded body 2 on the basis of the following Expression (I).

$$Porosity ( \% ) = ( 1 - \frac{Mass of the active material molded body}{( Apparent volume ) \times ( Density of the active material )} ) \times 100 \qquad ( I )$$

In addition, although details will be given later, the porosity of the active material molded body 2 can be controlled by using a pore forming material, which is composed of a particle-shaped organic material, in a process of forming the active material molded body 2.

The solid electrolyte layer (first solid electrolyte layer) 3 uses a solid electrolyte as a formation material (constituent material), and is provided to come into contact with the surface, which includes a surface inside the pore (void) of the active material molded body 2, of the active material molded body 2.

Examples of the solid electrolyte includes an oxide, a sulfide, a halide, and a nitride such as SiO₂—P₂O₅—Li₂O, SiO₂—P₂O₅—LiCl, Li₂O—B₂O₃, Li₂O—LiCl—B₂O₃, Li_{3.4}V_{0.6}Si_{0.4}O₄, Li₁₄ZnGe₄O₁₆, Li_{3.6}V_{0.4}Ge_{0.6}O₄, Li_{1.3}Ti_{1.7}Al_{0.3} (PO₄)₃, Li_{2.88}PO_{3.73}N_{0.14}, LiNbO₃, Li_{0.35}La_{0.55}TiO₃, Li₇La₃Zr₂O₁₂, Li₂S—SiS₂, Li₂S—SIS₂—LiI, Li₂S—SiS₂—P₂S₅, LiPON, Li₃N, LiI, LiI—CaI₂, LiI—CaO, LiAICl₄, LiAlF₄, LiI—Al₂O₃, LiF—Al₂O₃, LiBr—Al₂O₃, Li₂O—TiO₂, La₂O₃—Li₂O—TiO₂, Li₃NI₂, Li₃N—LiI—LiOH, Li₃N—LiCl, Li₆NBr₃, LiSO₄, LI₄SiO₄, Li₃PO₄—Li₄SiO₄, Li₃BO₃—Li₄SiO₄, Li₃BO₃—Li₂CO₃, Li₄GeO₄—Li₃VO₄, LiSiO—Li₃VO₄, Li₄GeO₄—Zn₂GeO₂, LiSiO₄—LiMoO₄, and LiSiO₄—Li₄ZrO₄. In addition, the solid electrolyte may be crystalline or amorphous. In addition, in this specification, a solid-solution, in which a part of atoms of the composition is substituted with other transition metals, typical metals, alkali metals, alkali rare-earth elements, lanthanoids, chalcogenides, halogens, and the like, can be used as the solid electrolyte.

A solid electrolyte, which is a constituent material of the solid electrolyte layer 3, is generated by baking (heating) a precursor of the solid electrolyte as described in a method of manufacturing the lithium secondary battery to be described later. During the baking, the solid electrolyte, which is generated, constitutes granular bodies (solid electrolyte particles) 31 which are constituted by secondary particles formed through granulation of primary particles, and have a particle shape. According to this, the solid electrolyte layer 3 is provided to come into contact with the surface, which includes a surface inside the pores of the active material molded body 2, of the active material molded body 2, but is constituted by an assembly of the granular bodies 31. Accordingly, as is the case with the active material molded body 2, the solid electrolyte layer 3 is also constituted by a porous body. Accordingly, the solid electrolyte layer 3 is formed so that the inside of the void of the active material molded body 2 is filled with the solid electrolyte layer 3. However, even after the filling, a part of the pores also exists. That is, in this embodiment, the composite material, which includes the active material molded body 2 and the solid electrolyte layer 3, has the pores.

Ion conductivity of the solid electrolyte layer 3 is preferably 1×10⁻⁵ S/cm or higher. When the solid electrolyte layer 3 has the ion conductivity, ions, which are included in the solid electrolyte layer 3 at a position distant from the surface of the active material molded body 2, also reach the surface of the active material molded body 2, and can contribute a battery reaction in the active material molded body 2. According to this, a utilization rate of the active material in the active material molded body 2 is improved, and thus it is possible to increase the capacity. At this time, when the ion conductivity is less than the lower limit, in the active material molded body 2, only an active material in the vicinity of a surface layer on a surface side that faces a counter electrode contributes to the battery reaction depending on a kind of the solid electrolyte layer 3, and thus there is a concern that the capacity decreases.

In addition, the “ion conductivity of the solid electrolyte layer 3” represents “total ion conductivity” that is the sum of “bulk conductivity” of the above-described inorganic electrolyte that constitutes the solid electrolyte layer 3, and “grain boundary ion conductivity” that is conductivity between crystal particles in a case where the inorganic electrolyte is crystalline.

In addition, for example, the ion conductivity of the solid electrolyte layer 3 can be measured as follows. First, solid electrolyte powers are press-molded into a tablet shape at 624 MPa, and the resultant press-molded body is baked in an atmospheric atmosphere at 700° C. for 8 hours. Then, a platinum electrode having a diameter of 0.5 cm and a thickness of 100 nm is formed on both surfaces of the press-molded body through sputtering, and then the ion conductivity is measured by an AC impedance method. As a measurement device, for example, an impedance analyzer (manufactured by AMETEK, Inc. model number: SI1260) is used.

The electron conduction layer 5 has a layered shape. In this embodiment, at the inside of the void (communication hole) of the active material molded body 2 in which the solid electrolyte layer 3 is formed, the electron conduction layer 5 covers a part of both the active material molded body 2 (active material particles 21) and the solid electrolyte layer 3 (granular bodies 31).

The electron conduction layer 5 has electron conductivity. Here, in a lithium secondary battery that does not include the electron conduction layer 5 configured as described above, delivery of electrons is conducted between the plurality of active material particles 21. The electron conductivity of the active material particles 21 is intrinsic properties of the electrode active material that is a constituent material of the active material particles 21. According to this, when it is intended to decrease electrical resistance of the active material particles 21, a range of selection of the kind of the electrode active material decreases. In addition, the electrode active material has electron conductivity lower than that of the metal. Accordingly, even when selecting an electrode active material having high electron conductivity, it cannot be said that the electron conductivity of the active material particles 21 is sufficiently excellent. As described above, in the lithium secondary battery that does not include the electron conduction layer 5, internal resistance in the active material molded body 2 increases, and thus it is difficult to realize the high output and the high capacity of the lithium secondary battery.

In contrast, when the electron conduction layer 5 having conductivity covers a part of both the active material molded body 2 and the solid electrolyte layer 3, it is possible to conduct electrons to the inside of the electron conduction layer 5, or it is possible to deliver electrons between the plurality of active material particles 21 through the electron conduction layer 5. That is, the electron conduction layer 5 functions as an electron conduction path in the composite body 4, and can smoothly supply a current to the current collector 1, and thus the internal resistance in the composite body 4 decreases. In addition, as described above, it is possible to allow the electron conduction layer 5 to function as the electron conduction path, and thus a range of selection of the kind of the electrode active material that is used in the active material particles 21 increases. As a result, it is accomplish the high output and the high capacity of the lithium secondary battery 100. In addition, the electron conduction inside the electron conduction layer 5, and the delivery of electrons between the plurality of active material particles 21 through the electron conduction layer 5 are stably maintained over a long period of time.

According to this, when the electrode composite body 10 including the electron conduction layer 5 configured as described above is applied to the lithium secondary battery 100, the lithium secondary battery 100 stably maintains the high output and the high capacity over a long period of time.

In addition, in this embodiment, as described above, the electron conduction layer 5 covers a part of both the active material molded body 2 (active material particles 21) and the solid electrolyte layer 3 (granular bodies 31). According to this, the electron conduction layer 5 is formed between the active material particles 21 adjacent to each other, between the granular bodies 31 adjacent to each other, and between the active material particle 21 and the granular body 31 which are adjacent to each other. As a result, the electron conduction path obtained by the electron conduction layer 5 is formed in a network shape, and thus it is possible to reliably lower the internal resistance in the composite body 4.

It is preferable that the electron conductivity of the electron conduction layer 5 is higher than the electron conductivity of the active material molded body. According to this, it is possible to allow the electron conduction layer 5 to reliably exhibit a function as the electron conduction path, and thus it is possible to reliably lower internal resistance in the composite body 4.

In addition, the electron conduction layer 5 may have any configuration as long as the electron conductivity is provided, and at least one kind of a carbon-containing coat layer and a metal layer is preferable. According to this, it is possible to allow the electron conduction layer 5 to exhibit excellent electron conductivity.

A formation material (constituent material) of the carbon-containing coat layer is not particularly limited, and examples thereof include a carbon material including graphite such as artificial graphite, flake graphite, scaly graphite, and earthy graphite, and carbon black such as channel black, furnace black, and acetylene black, and the like. In addition, the carbon-containing coat layer may further include a binder for molding thereof, and the like.

In addition, as the formation material (constituent material) of the metal layer, the material, which is exemplified as the formation material of the current collector 1, can be used.

In addition, it is preferable that an average film thickness of the electron conduction layer 5 is 0.1 μm to 10 μm, and more preferably 0.1 μm to 5 μm. When the average film thickness of the electron conduction layer 5 is set in the above-described range, it is possible to more reliably form the electron conduction layer 5 between the active material particles 21 adjacent to each other, between the granular bodies 31 adjacent to each other, and between the active material particle 21 and the granular body 31 which are adjacent to each other. As a result, the electron conduction inside the electron conduction layer 5, and the delivery of electrons between the plurality of active material particles 21 through the electron conduction layer 5 can be stably maintained over a long period of time.

In addition, although details will be described later, the one surface 4a of the composite body 4 is formed as a polished surface that is subjected to polishing during manufacturing, and the active material molded body 2 is exposed from the solid electrolyte layer 3. According to this, in a case of performing the polishing, scratches (polishing scratches) which are traces of the polishing remain on the one surface 4a.

In addition, in the electrode composite body 10 of this embodiment, the active material molded body 2 can be molded without using an organic material such as a binder for joining of an active material, and a conductive auxiliary agent for securement of conductivity of the active material molded body 2 during molding thereof, and in this case, the active material molded body 2 is constituted only almost by an inorganic material. Specifically, in the electrode composite body 10 of this embodiment, when heating the composite body 4 (active material molded body 2, the solid electrolyte layer 3, and the electron conduction layer 5) at 400° C. for 30 minutes, a mass reduction rate is 5% by mass or less. The mass reduction rate is preferably 3% by mass or less, more preferably 1% by mass or less, and still more preferably a range in which the mass reduction is not observed, or an error range. That is, the mass reduction rate when heating the composite body 4 at 400° C. for 30 minutes may be 0% by mass or greater. Since the composite body 4 has this mass reduction rate, a material such as a solvent and absorbed water which is evaporated under predetermined heating conditions, and an organic material that is combusted or oxidized, and is vaporized under predetermined heating conditions is included in the composite body 4 only in 5% by mass or less on the basis of the entirety of the configuration.

In addition, the mass reduction rate of the composite body 4 can be calculated as follows by using a thermogravimetry-differential thermal analyzer (TG-DTA). First, the composite body 4 is heated under predetermined heating conditions, the mass of the composite body 4 after heating under the predetermined heating conditions is measured, and the mass reduction rate is calculated from a ratio between the mass before heating and the mass after heating.

In the electrode composite body 10 of this embodiment, a communication hole in which a plurality of pores communicate with each other at the inside of the active material molded body 2 in a network shape, and a solid portion of the active material molded body 2 also forms a network structure. For example, it is known that LiCoO₂ that is a positive electrode active material has anisotropy in electron conductivity of a crystal. According to this, when forming an active material molded body by using LiCoO₂ as a formation material, in a configuration, in which pores extend in a specific direction, similar to a case where pores are formed through machining, it is considered that electron conduction is less likely to occur at the inside of the active material molded body depending on a direction of a crystal which exhibits electron conductivity. However, as is the case with the active material molded body 2, when the pores communicate with each other in a network shape, and the solid portion of the active material molded body 2 has the network structure, it is possible to form a continuous surface, which is electrochemically active, without depending on the anisotropy in the electron conductivity of or ion conductivity of a crystal. According to this, it is possible to secure relatively satisfactory electron conductivity without depending on a kind of an active material that is used.

In addition, in the electrode composite body 10 of this embodiment, since the composite body 4 has the above-described configuration, the addition amount of the binder or the conductive auxiliary agent which is included in the composite body 4 is suppressed, and a capacity density per unit volume of the electrode composite body 10 is further improved in comparison to a case of using the binder or the conductive auxiliary agent.

In addition, in the electrode composite body 10 (composite body 4) of this embodiment, the solid electrolyte layer 3 also comes into contact with a surface inside the pores of the porous active material molded body 2. According to this, a contact area between the active material molded body 2 and the solid electrolyte layer 3 further increases in comparison to a case where the active material molded body 2 is not a porous body, or a case where the solid electrolyte layer 3 is not formed inside the pores, and thus it is possible to reduce interfacial impedance. Accordingly, satisfactory charge migration is possible at an interface between the active material molded body 2 and the solid electrolyte layer 3.

In addition, in the electrode composite body 10 of this embodiment, the current collector 1 comes into contact with the active material molded body 2 that is exposed from the one surface of the composite body 4, and the solid electrolyte layer 3 intrudes into the pores of the porous active material molded body 2, and comes into contact with the surface of the active material molded body 2, which includes a surface inside the pores, other than the surface that comes into contact with the current collector 1. In the electrode composite body 10 having the above-described structure, it is apparent that a contact area (second contact area) between the active material molded body 2 and the solid electrolyte layer 3 is greater than a contact area (first contact area) between the current collector 1 and the active material molded body 2.

Here, in a case where the electrode composite body has a configuration in which the first contact area is the same as the second contact area, charge migration more easily occurs at an interface between the current collector 1 and the active material molded body 2 in comparison to an interface between the active material molded body 2 and the solid electrolyte layer 3, and thus a bottle-neck phenomenon relating to charge migration occurs at the interface between the active material molded body 2 and the solid electrolyte layer 3. According to this, satisfactory charge migration deteriorates as a whole of the electrode composite body. However, in the electrode composite body 10 of this embodiment, since the second contact area is greater than the first contact area, it is easy to remove the above-described bottle-neck phenomenon, and thus it is possible to realize satisfactory charge migration as a whole of the electrode composite body.

Accordingly, the electrode composite body 10, which is produced by the manufacturing method according to the embodiment described below, and having the above-described configuration improves the capacity of the lithium secondary battery using the electrode composite body 10, and it is possible to allow the lithium secondary battery to attain a high output.

In addition, in the composite body 4 that includes the active material molded body 2 and the solid electrolyte layer 3, both the active material molded body 2 and the solid electrolyte layer 3 are exposed from the one surface 4a, and the solid electrolyte layer 3 is exposed alone from the other surface 4b. In this state, the current collector 1 is joined to the one surface 4a, and the electrode 20 is joined to the other surface 4b. When this configuration is employed, in the lithium secondary battery 100, it is possible to prevent the electrode 20 and the current collector 1 from being connected through the active material molded body 2, that is, it is possible to prevent short-circuiting. That is, the solid electrolyte layer 3 also functions as a short-circuit preventing layer that prevents occurrence of short-circuiting in the lithium secondary battery 100.

The electrode 20 is provided on the other surface (surface on the other side) 4b of the composite body 4 which is opposite to the current collector 1 to come into contact with the solid electrolyte layer 3 without coming into contact with the active material molded body 2.

In a case where the active material molded body 2 is composed of a positive electrode active material, the electrode 20 functions as a negative electrode.

Examples of a formation material (constituent material) of the electrode 20 include lithium (Li).

Although not particularly limited, for example, the thickness of the electrode 20 is preferably 1 μm to 100 μm, and more preferably 20 μm to 50 μm.

The above-described lithium secondary battery 100 of the first embodiment can be manufactured, for example, by the following manufacturing method.

### Method of Manufacturing Lithium Secondary Battery

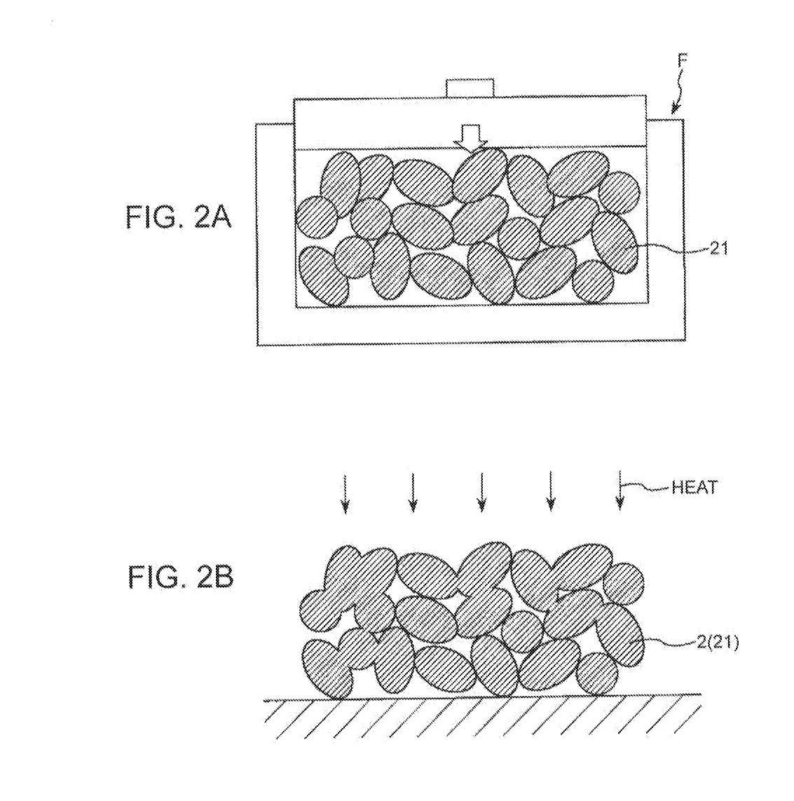

FIG. 2A to FIG. 6 are views illustrating a method of manufacturing the lithium secondary battery illustrated in FIG. 1. In addition, in the following description, an upper side and a lower side in FIG. 2A to FIG. 5C are referred to as “upper” and “lower” for convenience of explanation. In addition, in FIG. 2A to FIG. 6, dimensions, ratios, and the like of respective constituent elements are appropriately made different for easy understanding of the drawings.

(1) First, the plurality of active material particles 21 having a particle shape are heated to three-dimensionally connect the plurality of active material particles 21 to each other, thereby obtaining the active material molded body 2 that is constituted by a porous body (first process).

For example, as illustrated in FIGS. 2A and 2B, the active material molded body 2 is formed as follows. The plurality of active material particles 21 are compressed by using a mold F to mold a compressed molded body (refer to FIG. 2A), and the compressed molded body that is obtained is subjected to a heat treatment (heating) so as to three-dimensionally connect the plurality of active material particles 21 (refer to FIG. 2B).

It is preferable that the heat treatment (heating) is performed under temperature conditions of equal to or higher than 850° C. and lower than 1000° C. According to this, it is possible to reliably obtain the active material molded body 2 in which the active material particles 21 are sintered and integrated with each other.

At this time, when a treatment temperature is lower than 850° C., sintering does not progress sufficiently and electron conductivity itself inside a crystal of the active material deteriorates depending on a kind of lithium composite oxide that is used, and thus there is a concern that a desired output may not be obtained in the lithium secondary battery 100 that is obtained.

In addition, when the treatment temperature is higher than 1000° C., lithium ions excessively vaporize from the inside of a crystal of the lithium composite oxide, and the electron conductivity of the lithium composite oxide decrease, and thus there is a concern that the capacity of the electrode composite body 10 that is obtained may decrease.

Accordingly, it is preferable that the treatment temperature is equal to or higher than 850° C. and lower than 1000° C. to obtain an appropriate output and an appropriate capacity, more preferably equal to or higher than 875° C. and lower than 1000° C., and still more preferably 900° C. to 920° C.

In addition, it is preferable that the heat treatment of this process is performed for 5 minutes to 36 hours, and more preferably 4 hours to 14 hours.

When the above-described heat treatment is performed, growth of a grain boundary inside the active material particles 21, or sintering between the active material particles 21 progresses, and thus the active material molded body 2 that is obtained is likely to maintain a shape, and thus it is possible to reduce the amount of a binder that is added to the active material molded body 2, In addition, bonds are formed between the active material particles 21 through the sintering, and thus it is possible to form a migration route of electrons between the active material particles 21.

In addition, as the formation material of the active material particles 21, LiCoO₂ can be appropriately used. According to this, the above-described effect can be more significantly exhibited. That is, it is possible to more reliably obtain the active material molded body 2 in which the active material particles 21 are sintered and integrated with each other.

In addition, in the active material molded body 2 that is obtained, a plurality of the pores of the active material molded body 2 are configured as a communication hole in which the plurality of pores communicate with each other in a network shape on an inner side of the active material molded body 2.

In addition, an organic polymer compound such as polyvinylidene fluoride (PVDF) and polyvinyl alcohol (PVA) may be added to the formation material, which is used to form the active material particles 21, as a binder. The binder is combusted or oxidized in the heat treatment of the process, and thus the amount of the binder is reduced.

In addition, a particle-shaped pore forming material, in which a polymer or a carbon powder is used as a formation material, is preferably added to the above-described formation material, which is used, as a mold of the pores during compacting molding. When the pore forming material is mixed in, it is easy to control porosity of the active material molded body. The pore forming material is discomposed and removed through combustion or oxidation during the heat treatment, and the amount of the pore forming material is reduced in the active material molded body that is obtained.

An average particle size of the pore forming material is preferably 0.5 μm to 10 μm.

In addition, it is preferable that the pore forming material includes particles (first particles) in which a material with deliquescency is used as a formation material. When the first particles deliquesce, water, which occurs at the periphery of the first particles, functions as a binder for joining of the particle-shaped lithium composite oxide, and thus it is possible to maintain a shape from compression molding of the lithium composite oxide having a particle shape to the heat treatment. According to this, it is possible to obtain the active material molded body without addition of another binder or while reducing the amount of the binder that is added, and it is possible to realize the electrode composite body with a high capacity.

Examples of the first particles include particles in which polyacrylic acid is used as a formation material.

In addition, it is preferable that the pore forming material further includes particles (second particles) in which a material with no deliquescency is used as a formation material. The pore forming material including the second particles is easy to handle. In addition, when the pore forming material has the deliquescency, the porosity of the active material molded body may deviate from a desired setting value depending on the amount of water moisture at the periphery of the pore forming material, but when the second particles, which does not deliquesce, is simultaneously included as the pore forming material, it is possible to suppress the deviation in the porosity.

In addition, the active material molded body 2 may be obtained by using a method of heating slurry in which the active material particles 21 are dispersed in a solvent in addition to the method of obtaining the active material molded body 2 by compression-molding the active material particles 21 and heating the resultant compressed molded body.

That is, the method using the slurry includes a preparation process of preparing slurry that contains the active material particles 21, and a drying process of heating the slurry to obtain the active material molded body 2. Hereinafter, these processes will be described.

[1-1] First, a binder is dissolved in a solvent, and the active material particles 21 are dispersed in the resultant mixture to prepare slurry 26. In addition, a dispersing agent such as oleylamine may be included in the slurry 26.

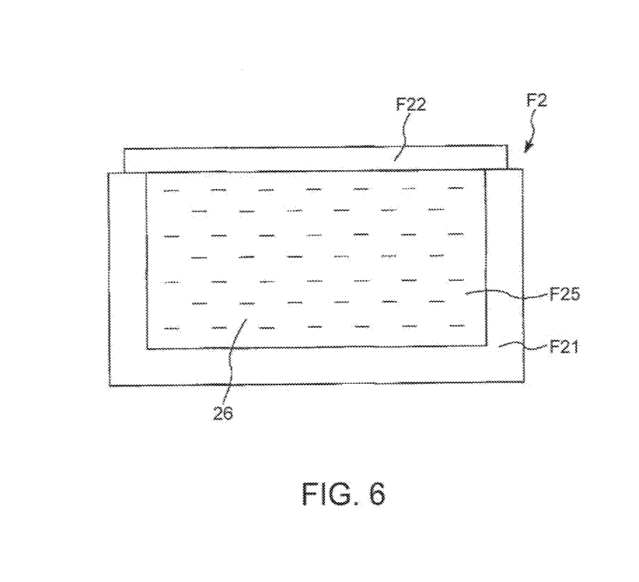

Then, a mold F2, which includes a lower portion P21 having a concave portion F25, and a lid portion F22, is prepared, and the slurry 26 is supplied dropwise to the concave portion F25 of the lower portion F21, and then the lower portion F21 is covered with the lid portion F22 (refer to FIG. 6).

In addition, the amount of the active material particles 21 contained in the slurry 26 is preferably 10% by weight to 60% by weight, and more preferably 30% by weight to 50% by weight. According to this, the active material molded body 2 with a high filling rate is obtained in the subsequent process [1-2].

In addition, although not particularly limited, examples of the binder include a cellulose-based binder, an acryl-based binder, a polyvinyl alcohol-based binder, a polyvinyl butyral-based binder, and the like in addition to polycarbonate, and one or more kinds of these may be used in combination.

In addition, although not particularly limited, as the solvent, for example, an aprotonic solvent is preferable. According to this, it is possible to reduce deterioration of the active material particles 21 due to contact with the solvent.

Specific examples of the aprotonic solvent include butanol, ethanol, propanol, methyl isobutyl ketone, toluene, xylene, and the like, and a single solvent or a mixed solvent thereof can be used as the solvent.

[1-2] Next, the slurry 26, which contain the active material particles 21, is heated to dry the slurry 26 and to sinter the active material particles 21 which are contained in the slurry 26, thereby obtaining the active material molded body 2.

In addition, although not particularly limited, examples of a method of heating the slurry 26 which contain the active material particles 21 include a heating method of spraying and drying the slurry 26 by using a spray dryer and the like.

In addition, heating conditions during heating of the slurry 26 are set to the same as conditions during the heat treatment of the compressed molded body as described above.

In addition, it is preferable that heating of the slurry 26 is performed in a multistage in which a temperature condition rises step by step. Specifically, it is preferable that after drying to room temperature, a temperature is raised from room temperature to 300° C. for 2 hours, the temperature is raised from 300° C. to 350° C. for 0.5 hours, the temperature is raised to 1000° C. for 2 hours, and then the concave portion P25 is covered with the lid portion F22, and baking is performed at 1000° C. for 8 hours. When the temperature is raised under the conditions, it is possible to reliably bake out the binder that is included in the solvent.

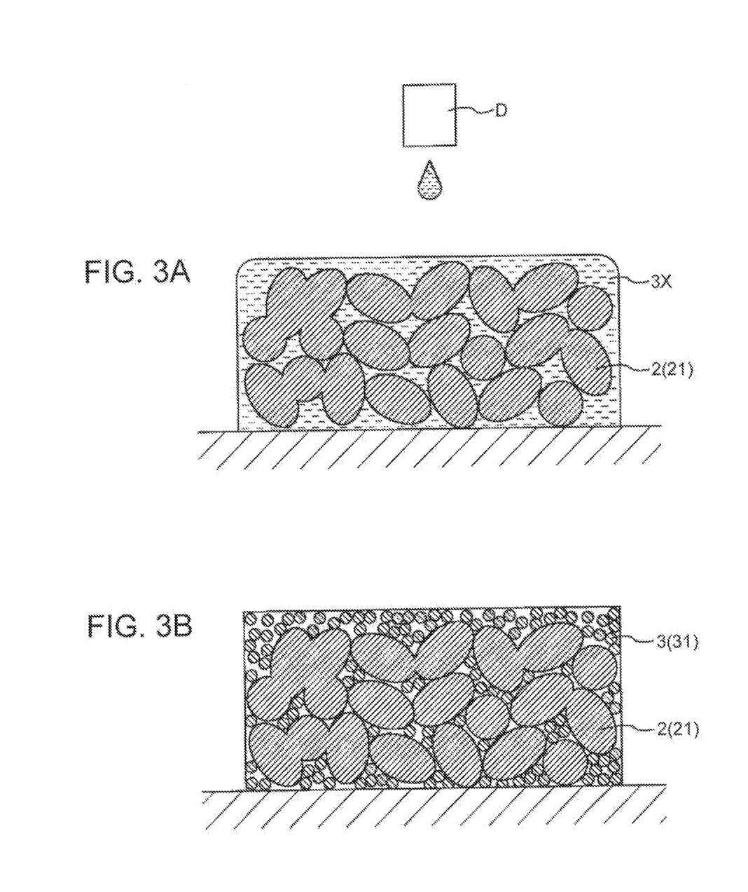

It is also possible to obtain the active material molded body 2 through the above-described processes.

[2] Then, as illustrated in FIGS. 3A and 3B, a liquid substance 3X, which includes a precursor of a solid electrolyte, is applied to the surface, which includes a surface inside the communication hole of the active material molded body 2, of the active material molded body 2 (FIG. 3A), and then, baking (heating) is performed, thereby forming the solid electrolyte layer 3 in which the precursor is set as an inorganic solid electrolyte and which is constituted by the granular bodies 31 (FIG. 3B; second process).

In addition to the precursor, the liquid substance 3X may include a solvent in which the precursor is soluble. In a case where the liquid substance 3X includes the solvent, after the application of the liquid substance 3X, the solvent may be appropriately removed before baking. It is possible to employ a method selected from typically known methods such as heating, decompression, and blowing, or a method in which one or more kinds of the methods are combined for removal of the solvent.

Here, since the solid electrolyte layer 3, which is constituted by the granular bodies 31, is formed through application of the liquid substance 3X having flowability, the solid electrolyte can also be formed on an inner surface of the fine pores of the active material molded body 2 in a satisfactory manner. According to this, it is easy to increase a contact area between the active material molded body 2 and the solid electrolyte layer 3, and a current density at the interface between the active material molded body 2 and the solid electrolyte layer 3 is reduced. As a result, it is possible to easily obtain a large output.

The application of the liquid substance 3X can be performed by various methods as long as the liquid substance 3X penetrates into the pores of the active material molded body 2. For example, the application may be performed by adding the liquid substance 3X dropwise to the active material molded body 2 that is placed, the application may be performed by immersing the active material molded body 2 with the liquid substance 3X that is stored, or the application may be performed by bringing an end of the active material molded body 2 into contact with the liquid substance 3X that is stored so as to impregnate the pores with the liquid substance 3X by using a capillary phenomenon. FIG. 3A illustrates a method of adding the liquid substance 3X dropwise by using a dispenser D.

In addition, in this process, the solid electrolyte is generated by baking (heating) the precursor of the solid electrolyte, and during the baking, the solid electrolyte that is generated forms the granular bodies 31 which are constituted by secondary particles formed through granulation of primary particles of the solid electrolyte. Accordingly, the solid electrolyte layer 3 is formed inside the fine pore (void) of the active material molded body 2, and is also provided as an assembly of the granular bodies 31. According to this, as is the case with the active material molded body 2, the solid electrolyte layer 3 is also formed as a porous body. Accordingly, the void of the active material molded body 2 is filled with the solid electrolyte layer 3, but a part of the void also remains even after the filling. That is, in this embodiment, the composite body that is constituted by the active material molded body 2 and the solid electrolyte layer 3 is formed in a state of including the void.

In addition, examples of the precursor of the solid electrolyte include the following (A), (B), and (C).

(A) A composition that includes a metal element of the inorganic solid electrolyte in a ratio according to a compositional formula of the inorganic solid electrolyte, and has a salt that becomes the inorganic solid electrolyte through oxidation
(B) A composition having a metal alkoxide that includes a metal element of the inorganic solid electrolyte in a ratio according to a compositional formula of the inorganic solid electrolyte
(C) A dispersed solution in which inorganic solid electrolyte fine particles or fine particle sol including a metal element of the inorganic solid electrolyte in a ratio according to a compositional formula of the inorganic solid electrolyte is dispersed in a solvent or (A) or (B)

In addition, the salt that is included in (A) includes a metal complex. In addition, (B) is a precursor in a case of forming the inorganic solid electrolyte by using a so-called sol-gel method.

The precursor is baked under an atmospheric atmosphere at a temperature lower than the temperature during the heat treatment to obtain the active material molded body 2 as described above. Specifically, a baking temperature is preferably set to a temperature range of 300° C. to 700° C. According to this, the inorganic solid electrolyte is generated from the precursor through the baking, and thus the solid electrolyte layer 3 is formed. In addition, as a formation material of the solid electrolyte layer, Li₇La₃Zr₂O₁₂, can be appropriately used.

When the baking is performed in the above-described temperature range, at an interface of the active material particles 21 in the active material molded body 2, and the solid electrolyte layer 3, a solid phase reaction occurs through mutual diffusion of elements which respectively constitute the active material particles 21 and the solid electrolyte layer 3, and it is possible to suppress generation of a by-product that is electrochemically inactive. In addition, crystallinity of the inorganic solid electrolyte is improved, and thus it is possible to improve ion conductivity of the solid electrolyte layer 3. In addition, a sintered portion is generated at the interface between the active material particles 21 and the solid electrolyte layer 3, and thus electron migration at the interface becomes easy. According to this, the capacity or the output of the lithium secondary battery 100 is improved.

In addition, the baking may be performed through one time of heat treatment, or may be performed by dividing the heat treatment into a first heat treatment in which the precursor is deposited on the surface of the porous body, and a second heat treatment in which heating is performed under a temperature condition that is equal to or higher than a treatment temperature in the first heat treatment and equal to or lower than 700° C. When the baking is performed through the heat treatment performed step by step, it is possible to easily form the solid electrolyte layer 3 at a desired position.

[3] Then, as illustrated in FIGS. 3A and 3B, the electron conduction layer 5 is formed to cover the surface of the active material molded body 2 and the solid electrolyte layer 3 (third process).

In a case where the electron conduction layer 5 is constituted by a carbon-containing coat layer, for example, the electron conduction layer 5 can be formed by using a sol-gel method. In a case where the electron conduction layer 5 is constituted by a metal layer, for example, the electron conduction layer 5 can be formed by an electroless plating method.

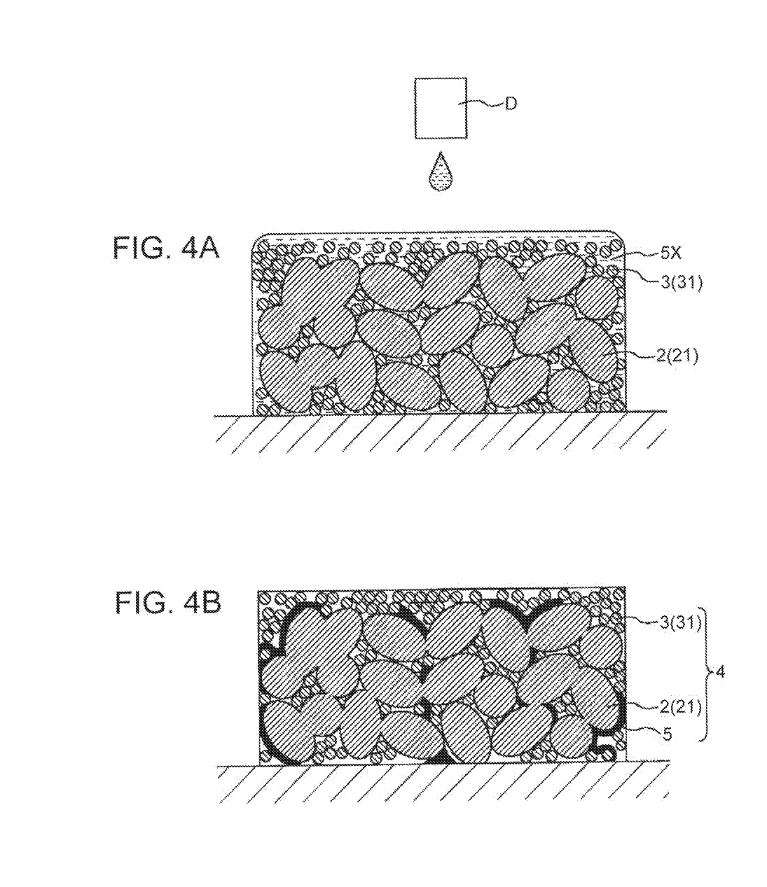

That is, in a case where the electron conduction layer 5 is constituted by the carbon-containing coat layer, a liquid substance 5X including a precursor of a constituent material of the carbon-containing coat layer is applied (FIG. 4A) to fill a void of a composite material including the active material molded body 2 and the solid electrolyte layer 3 with the liquid substance 5X. Then, the liquid substance 5X becomes sol after a hydrolysis reaction, and a polymerization and condensation reaction. Then, the reactions are allowed to further progress to obtain gel, and a heat treatment is performed at a temperature lower than a combustion temperature of carbon, thereby forming the carbon-containing coat layer (FIG. 4B).

In addition, in a case where the electron conduction layer 5 is constituted by a metal layer, a catalyst is adsorbed into the void of the composite material including the active material molded body 2 and the solid electrolyte layer 3, and a liquid substance 5X including a precursor (for example, a metal salt such as a nitrate and a sulfate) of a constituent material of the metal layer is applied (FIG. 4A) to fill the void with the liquid substance 5X. Then, a metal element is allowed to precipitate, thereby forming a metal layer (FIG. 4B).

According to the above-described method, in the void, the electron conduction layer 5 is non-selectively formed at an exposed site at which the active material molded body 2 and the solid electrolyte layer 3 do not comes into contact with each other, thereby forming the composite body 4 including the active material molded body 2, the solid electrolyte layer 3, and the electron conduction layer 5.

In addition, it is possible to form the electron conduction layer 5 in this process [3] without through thermal hysteresis during formation of the active material molded body 2 and the solid electrolyte layer 3 in the processes [1] and [2], and thus a range of selection of a material that is used in the electron conduction layer 5 increases, and the electron conduction layer 5 can be formed without modification and deterioration. As a result, output characteristics of the lithium secondary battery 100 that is obtained are improved. In addition, it is possible to accurately suppress unnecessary interposing of the electron conduction layer 5 between the active material molded body 2 and the solid electrolyte layer 3, and thus the size of the contact area between the active material molded body 2 and the solid electrolyte layer 3 is sufficiently secured. Accordingly, delivery of lithium ions can be smoothly performed between the active material molded body 2 and solid electrolyte layer 3.

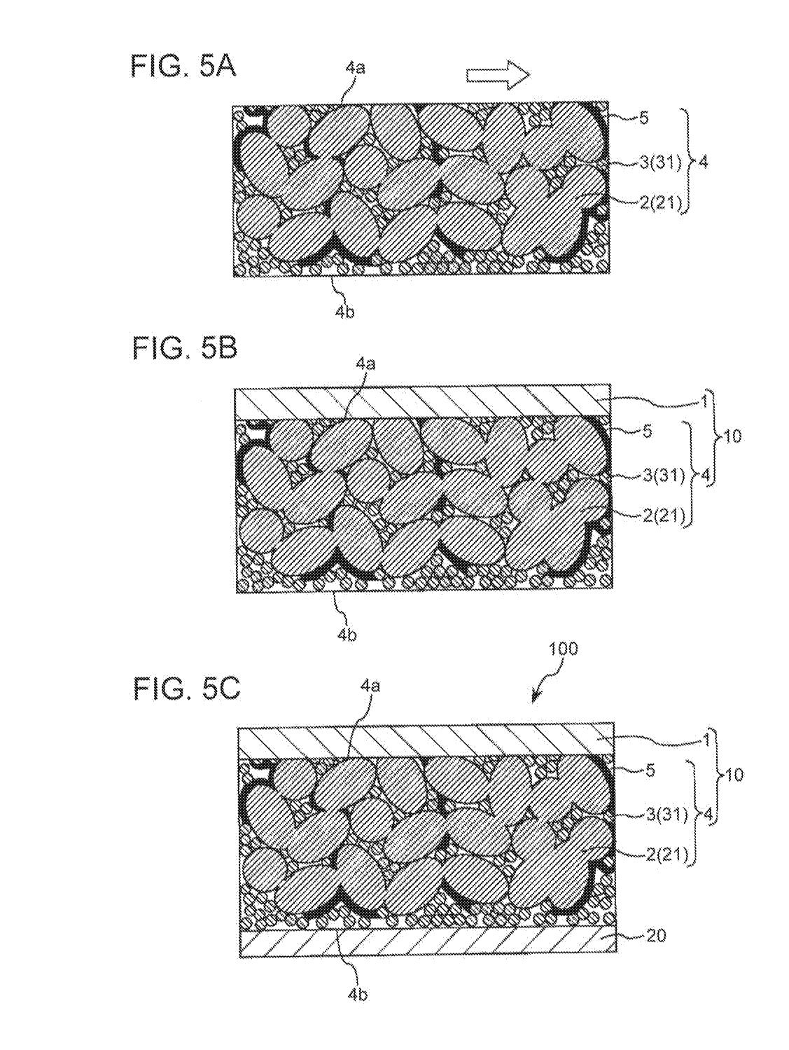

In addition, the application of the liquid substance 5X can be performed by using the same method as the method described in the application of the liquid substance 3X, In addition, FIG. 4A illustrates a method in which the liquid substance 5X is added dropwise by using the dispenser D.

[4] Then, the one surface 4a of the composite body 4 is ground and polished to expose both the active material molded body 2 and the solid electrolyte layer 3 from the one surface 4a (refer to FIG. 5A).

In addition, at this time, it is preferable that the electron conduction layer 5 is also exposed.

In addition, in this case, scratches (grinding and polishing scratches) which are traces of the grinding and polishing remain on the one surface 4a.

In addition, in the process [2], when forming the composite material including the active material molded body 2 and the solid electrolyte layer 3, both the active material molded body 2 and the solid electrolyte layer 3 may be exposed from the one surface 4a. In this case, the grinding and polishing with respect to the one surface 4a of the composite body 4, that is, this process [4] may be omitted.

[5] Then, as illustrated in FIG. 5B, the current collector 1 is joined to the one surface 4a of the composite body 4 (fourth process).

According to this, the electrode composite body (electrode composite body according to the invention) 10 including the active material molded body 2, the solid electrolyte layer 3, the electron conduction layer 5, and the current collector 1 is formed.

The joining of the current collector 1 may be performed by joining a current collector, which is formed as a separate body, to the one surface 4a of the composite body 4. In addition, the above-described formation material of the current collector 1 may be formed on the one surface 4a of the composite body 4 to form the current collector 1 on the one surface 4a of the composite body 4.

In addition, as a method of forming the current collector 1, various kinds of physical vapor deposition (PVD) methods and chemical vapor deposition (CVD) methods can be used.

In addition, the method of manufacturing the electrode composite body 10 according to the invention includes the above-described processes [1] to [5].

[6] Then, as illustrated in FIG. 5C, the electrode 20 is joined to the other surface 4b of the composite body 4.

The joining of the electrode 20 may be performed by joining an electrode, which is formed as a separate body, to the other surface 4b of the composite body 4. In addition, the above-described formation material of the electrode 20 may be formed on the other surface 4b of the composite body 4 to form the electrode 20 on the other surface 4b of the composite body 4.

In addition, as the method of forming the electrode 20, it is possible to use the same method as the method of forming the current collector 1 in the process [5].

Through the above-described processes, the lithium secondary battery 100 is manufactured.

### Second Embodiment

Next, description will be given of a second embodiment in which the battery according to the invention is applied to the lithium secondary battery.

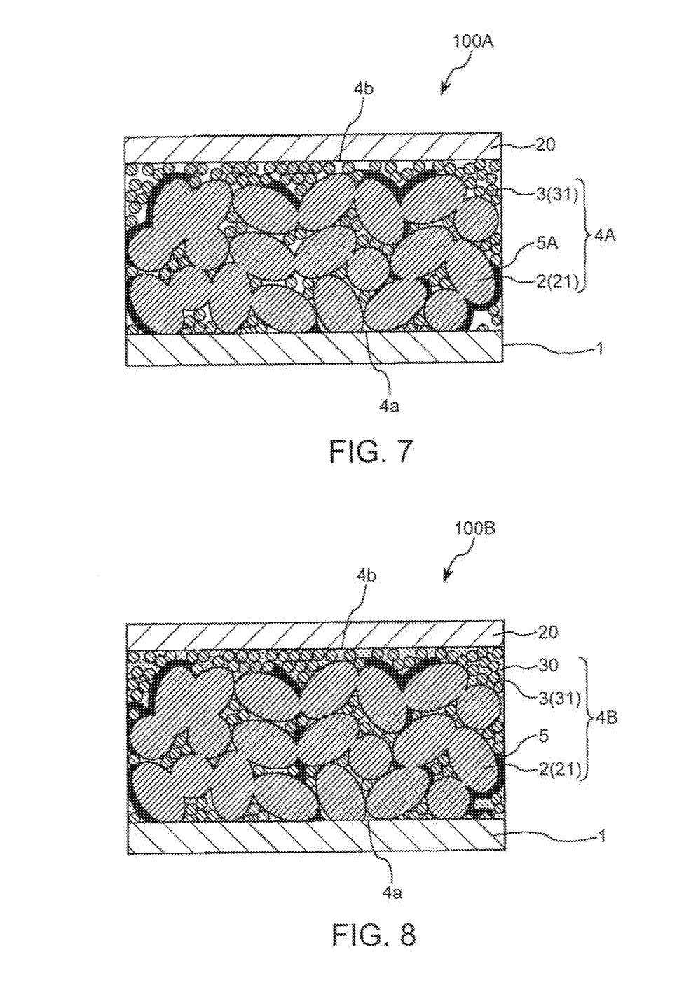

FIG. 7 is a longitudinal cross-sectional view of the second embodiment in which the battery according to the invention is applied to the lithium secondary battery.

Hereinafter, with respect to a lithium secondary battery 100A in the second embodiment, description will be made with focused to a difference from the lithium secondary battery 100 in the first embodiment, and description of the same configurations will not be repeated.

The lithium secondary battery 100A illustrated in FIG. 7 is the same as the lithium secondary battery 100 illustrated in FIG. 1 except that a composite body 4A having a configuration different from that of the composite body 4 is provided between the current collector 1 and the electrode 20 to be joined to the current collector 1 and the electrode 20.

That is, in the composite body 4A of the lithium secondary battery 100A of the second embodiment, an electron conduction layer 5A has a layered shape. In addition, at the inside of the void (communication hole) of an active material molded body 2 in which a solid electrolyte layer 3 is formed, an electron conduction layer 5A selectively covers a part of the active material molded body 2 between the active material molded body 2 (active material particles 21) and the solid electrolyte layer 3 (granular bodies 31). According to this, the electron conduction layer 5A is formed between active material particles 21 which are adjacent to each other, and thus an electron conduction path due to the electron conduction layer 5A is formed in a network shape. When the electron conduction layer 5A has this configuration, it is also possible to conduct electrons to the inside of the electron conduction layer 5A, or it is possible to deliver electrons between the plurality of active material particles 21 through the electron conduction layer 5A. Accordingly, it is possible to smoothly supply a current to the current collector 1.

In addition, in the electron conduction layer 5A configured as described above, the electron conduction layer 5A is configured as a metal layer, and can be formed by using, for example, the electrolytic plating method in the process [3] of forming the electron conduction layer.

Specifically, the liquid substance 5X including the precursor (for example, a metal salt such as a nitrate and a sulfate) of the constituent material of the metal layer is applied to fill the void of the composite material including the active material molded body 2 and the solid electrolyte layer 3 with the liquid substance 5X. Then, electrification is performed by using the active material molded body 2 as an electrode, and thus a metal element precipitates, and as a result, the metal layer is formed.

The same effect as in the first embodiment is also obtained by the lithium secondary battery 100A of the second embodiment.

### Third Embodiment

Next, description will be given of a third embodiment in which the battery according to the invention is applied to the lithium secondary battery.

FIG. 8 is a longitudinal cross-sectional view illustrating the third embodiment in which the battery according to the invention is applied to the lithium secondary battery.

Hereinafter, with respect to a lithium secondary battery 100B in the third embodiment, description will be made with focused to a difference from the lithium secondary battery 100 in the first embodiment, and description of the same configurations will not be repeated.

The lithium secondary battery 100B illustrated in FIG. 8 is the same as the lithium secondary battery 100 illustrated in FIG. 1 except that a composite body 4B having a configuration different from that of the composite body 4 is provided between the current collector 1 and the electrode 20 to be joined to the current collector 1 and the electrode 20.

That is, in the lithium secondary battery 100B of the third embodiment, the composite body 4B includes an active material molded body 2 that is constituted by a porous body including a void, a solid electrolyte layer 3 that is provided to come into contact with the surface, which include a surface inside the void of the active material molded body 2, of the active material molded body 2, an electron conduction layer 5 that covers a part of both the active material molded body 2 and the solid electrolyte layer 3 at the inside of the void of the active material molded body 2 in which the solid electrolyte layer 3 is formed, and a filling layer 30 that fills a void that remains through formation of the solid electrolyte layer 3 and the electron conduction layer 5. In other words, the composite body 4B further includes the filling layer 30 that is provided to fill the void that remains in the composite body 4 of the first embodiment.

The filling layer (second solid electrolyte layer) 30 is formed from a solid electrolyte that conducts lithium ions, and is amorphous (glassy) at room temperature. For example, the filling layer 30 is formed from a lithium oxide that has lithium ion conductivity and includes C, Si, or B. Specifically, the filling layer 30 may include at least one or a plurality of Li₂CO₃, Li₄SiO₄, and Li₃BO₃.

After the process [4], the filling layer 30 can be formed by using, for example, a method in which a remaining void is impregnated with a precursor solution of the filling layer 30 having flowability, that is, a precursor solution of a solid electrolyte that is amorphous at room temperature, and then heating is performed.

In addition, as the filling layer 30, it is preferable to use a material which is solid (amorphous) at room temperature and in which volume shrinkage during baking of the precursor is less than that of the solid electrolyte layer 3. In addition, it is preferable that the filling layer 30 is capable of being formed at a temperature equal to or lower than a formation temperature of the solid electrolyte layer 3. This is because mutual diffusion between the solid electrolyte layer 3 and the filling layer 30 is suppressed. For example, it is assumed that Li₇La₃Zr₂O₁₂ is used as the solid electrolyte layer 3, and Li₃BO₃ is used as the filling layer 30. In this case, a baking temperature during formation of the solid electrolyte layer 3 is approximately 700° C., but when the formation temperature during formation of the filling layer 30 is higher than 900° C., there is a concern that the mutual diffusion may occur between the solid electrolyte layer 3 and the filling layer 30. In addition, as a precursor of the filling layer 30, as is the case with the precursor of the solid electrolyte layer 3, any one of (A) to (C) may be used. The precursor is diluted with a solvent (for example, alcohol-based compound) to obtain a precursor solution. The remaining void is impregnated with the precursor solution. An impregnation method of the precursor solution is the same as the method described with respect to the solid electrolyte layer 3.

For example, a heating temperature during heating of the precursor solution filled in the void is set to 300° C. to 450° C.

The same effect as in the first embodiment is also obtained by the lithium secondary battery 100B of the third embodiment.

### Fourth Embodiment

Next, description will be given of a fourth embodiment in which the battery according to the invention is applied to the lithium secondary battery.

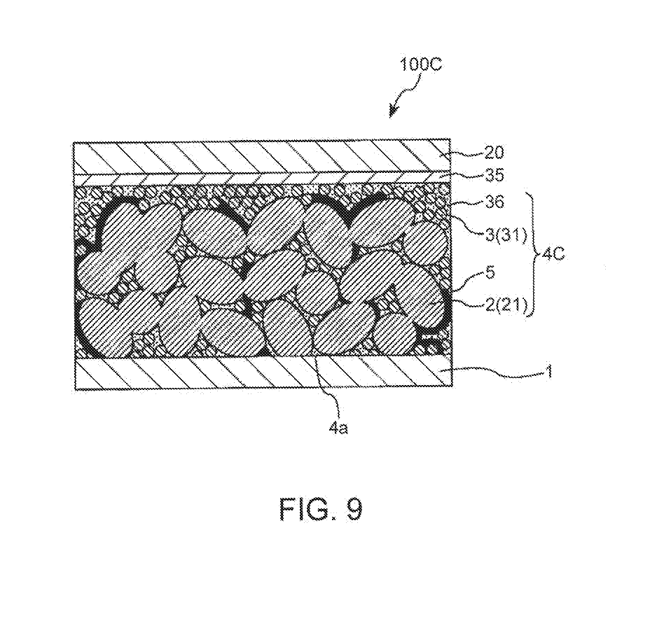

FIG. 9 is a longitudinal cross-sectional view of the fourth embodiment in which the battery according to the invention is applied to the lithium secondary battery.

Hereinafter, with respect to a lithium secondary battery 100C in the fourth embodiment, description will be made with focused to a difference from the lithium secondary battery 100 in the first embodiment, and description of the same configurations will not be repeated.

The lithium secondary battery 100C illustrated in FIG. 9 is the same as the lithium secondary battery 100 illustrated in FIG. 1 except that a composite body 4C having a configuration different from that of the composite body 4 is provided between the current collector 1 and the electrode 20 to be joined to the current collector 1 and the electrode 20.

That is, in the lithium secondary battery 100C of the fourth embodiment, the composite body 4C includes an active material molded body 2 that is constituted by a porous body including a void, a solid electrolyte layer 3 that is provided to come into contact with the surface, which include a surface inside the void of the active material molded body 2, of the active material molded body 2, an electron conduction layer 5 that covers a part of both the active material molded body 2 and the solid electrolyte layer 3 at the inside of the void of the active material molded body 2 in which the solid electrolyte layer 3 is formed, an electrolytic solution 36 that fills a void that remains through formation of the solid electrolyte layer 3 and the electron conduction layer 5, and an electrolytic solution impregnation layer 35 that is provided between the solid electrolyte layer 3 and the electrode 20 to be joined to both the solid electrolyte layer 3 and the electrode 20. In other words, the composite body 4C further includes the electrolytic solution 36 that is provided to fill the void that remains in the composite body 4 of the first embodiment, and the electrolytic solution impregnation layer 35 that is provided between the composite body 4C and the electrode 20.

In the composite body 4C, the electrolytic solution impregnation layer 35 is provided between the composite body 4C and the electrode 20, and when the electrolytic solution 36 is supplied from the electrolytic solution impregnation layer 35 to the void that remains to fill the void. According to this, in the void, the contact area between the active material molded body 2 and the solid electrolyte layer 3 decreases, and resistance between the active material molded body 2 and the solid electrolyte layer 3 increases. Accordingly, it is possible to reliably prevent ion conductivity from decreasing between the active material molded body 2 and the solid electrolyte layer 3.

In addition, typically, when repeating a charge and discharge cycle in the lithium secondary battery, a volume of the active material molded body or the solid electrolyte layer may vary. In contrast, in this embodiment, for example, even when the void becomes wide due to shrinkage of the volume, the electrolytic solution is further leached out from the electrolytic solution impregnation layer 35, and thus the void is filled with the electrolytic solution 36. On the other hand, even when the void becomes narrow due to expansion of the volume, the electrolytic solution 36 in the void intrudes into the electrolytic solution impregnation layer 35. As described above, the void of the composite body 4C serves as a buffer space that absorbs a volume variation, and this leads to securement of a charge conduction path. That is, it is possible to obtain a high-output lithium secondary battery.

In addition, the electrolytic solution 36 (an ion liquid inside the electrolytic solution impregnation layer) exists in a small amount, and is non-volatile, and thus there is no problem relating to liquid leakage and combustion.

The electrolytic solution impregnation layer 35 is a membrane that functions as a supply source of a polymer gel electrolyte. The electrolytic solution impregnation layer 35 is a film that is impregnated with an electrolytic solution that conducts lithium ions. That is, the electrolytic solution impregnation layer 35 includes a support body, and a polymer gel electrolyte (electrolytic solution).

The support body is configured to physically support the structure of the electrolytic solution impregnation layer (PEG film) 35. It is preferable that the support body does not precipitate impurities, does not react with other materials such as a polymer gel electrolyte, and has high wettability with an ion liquid, a Li salt, and a monomer. When the impurities precipitate, or a chemical reaction occurs, there is a concern that characteristics may vary. In addition, when the wettability is poor, there is a concern that it is difficult to uniformly form a polymer on the support body. In addition, the strength can be improved by increasing a ratio of a polymer component in the polymer gel electrolyte without using the support body, but when increasing the ratio of the polymer component, conductivity of Li is decreased, and thus it is preferable to use the support body. As the support body, for example, long fiber cellulose, or hydrophobic PVDF (polyvinylidene fluoride) is used.

It is preferable that the polymer gel electrolyte is chemically stable with respect to Li, and has characteristics capable of gelating and containing the electrolytic solution. In a typical polyethylene glycol (PEG) based film, it is possible to confirm a battery operation that is chemically stable with respect to Li. However, ion conductivity is low in the PEG film, and it is difficult to obtain a practical output as a battery. Accordingly, in this embodiment, the gel polymer electrolyte, from which an electrolytic solution does not volatilize, is used.

For example, the composite body 4C can be formed by using a method in which the electrolytic solution impregnation layer 35 is attached to the one surface of the composite body including the active material molded body 2 in which a void remains, and the solid electrolyte layer 3, and an electrolytic solution is supplied from the electrolytic solution impregnation layer 35 to the void.

For example, the electrolytic solution impregnation layer 35 is prepared by impregnating the support body (base material) with a precursor solution that includes the electrolytic solution and a monomer, and by subjecting the precursor solution to photopolymerization. The electrolytic solution includes an ion liquid and a lithium salt. As the ion liquid, for example, P13-TFSI (N-methyl-N-propyl pyrrolidinium bis(trifluoromethanesulfonyl) imide) is used. As the lithium salt, Li-TFSI (lithium N, N-bis(trifluoromethanesulfonyl) imide) is used. As the monomer, for example, polyethylene glycol diacrylate (TEGDA) is used. A PGE preparation solution is obtained by mixing a polymerization initiator and ethylene carbonate to the above-described electrolytic solution. As the polymerization initiator, for example, a radical type photopolymerization initiator (for example, IRGACURE651 manufactured by BASF Japan Ltd., 2-2-dimethoxy-1,2-diphenyl ethane-1-on) is used. For example, the polymerization initiator is mixed in a mixing ration of 6:1 in terms of weight ratio. The ethylene carbonate is used as a formation material of a solid electrolyte interface (SEI). The SEI is a film that inactivates and stabilizes the surface of a Li electrode. The SEI is generated through a reductive decomposition reaction of the electrolytic solution, and it is confirmed that a charge is consumed through a decomposition reaction of ethylene carbonate at a first cycle. The ethylene carbonate is mixed at a mixing ratio of 1. The support body is impregnated with the PGE preparation solution. As the support body, for example, a hydrophobic PVDF membrane filter (manufactured by Merck Millipore Corporation) is used. The support body, which is impregnated with the PGE preparation solution, is irradiated with light (for example, ultraviolet light) with a predetermined wavelength band to photopolymerize the monomer for polymeration, thereby obtaining the electrolytic solution impregnation layer 35. The electrolytic solution, which is included in the electrolytic solution impregnation layer 35, fills the void that remains, and functions as the electrolytic solution 36.

The electrolytic solution, which is included in the electrolytic solution impregnation layer 35, has satisfactory wettability as an oxide solid electrolyte, and intrudes into the void that remains through the solid electrolyte layer 3, and thus the void is filled with the electrolytic solution 36.

The same effect as in the first embodiment is also obtained by the lithium secondary battery 100C of the fourth embodiment.

Hereinbefore, description has been given of the electrode composite body, the method of manufacturing the electrode composite body, and the battery according to the invention on the basis of the embodiments illustrated in the drawings, but the invention is not limited thereto.

For example, configurations of respective portions in the electrode composite body and the battery according to the invention can be substituted with arbitrary configurations having the same function. In addition, other arbitrary configurations can be added to the invention. In addition, in the invention, two or more arbitrary configurations (characteristics) of the respective embodiments can be combined with each other.

In addition, the battery according to the invention is applicable to a lithium primary battery in addition to the lithium secondary battery that is described in the embodiments. In addition, the battery according to the invention is applicable to a sodium ion battery, a magnesium battery, and the like.

In addition, one or more arbitrary processes may be added to the method of manufacturing the electrode composite body according to the invention.

What is claimed is:

1. An electrode composite body, comprising:
a composite body; and
a first current collector that comes into contact with the composite body,
where the composite body includes,
an active material molded body in which a plurality of active material particles are connected to each other,
a solid electrolyte layer in which a plurality of solid electrolyte particles are connected to each other, and which comes into contact with the active material particles, and
a plurality of electron conduction layers which come into contact with the active material molded body and the solid electrolyte layer,
wherein the active material molded body includes a communication hole, and parts of the plurality of solid electrolyte particles come into contact with the active material molded body in the communication hole, and
the electron conduction layer is provided to come into contact with the active material molded body, and is disposed to be rich on a first current collector side.

2. The electrode composite body according to claim 1,
wherein electron conductivity of the electron conduction layer is higher than electron conductivity of the active material molded body.

3. The electrode composite body according to claim 1,
wherein the electron conduct ion layer selectively covers a part of the active material molded body between the active material molded body and the solid electrolyte layer.

4. The electrode composite body according to claim 1,
wherein the electron conduction layer is at least one kind of a carbon-containing coat layer and a metal layer.

5. The electrode composite body according to claim 1,
wherein in the composite body, the active material molded body, the solid electrolyte layer, and the electron conduction layer are exposed from a surface with which the first current collector comes into contact, and the solid electrolyte layer is exposed alone from at least a different one surface.

6. A method of manufacturing an electrode composite body, comprising:
forming an active material molded body in which a plurality of active material particles are connected to each other;
applying a precursor of a solid electrolyte to a surface of the active material molded body and heating the precursor to form a first composite body of the active material molded body and the solid electrolyte layer;
forming an electron conduction layer at the inside of the first composite body to form a second composite body; and
forming a first surface, from which the active material molded body, the solid electrolyte layer, and the electron conduction layer are exposed, in the second composite body, and joining a first current collector to the first surface,
wherein the active material molded body includes a communication hole,
the solid electrolyte layer includes a plurality of solid electrolyte particles, and parts of the plurality of solid electrolyte particles come into contact with the active material molded body in the communication hole, and
the electron conduction layer is formed to come into contact with the active material molded body, and is disposed to be rich on a first current collector side.

7. The method of manufacturing an electrode composite body according to claim 6,
wherein in the formation of the second composite body, a metal layer, which selectively covers a part of the active material molded body between the active material molded body and the solid electrolyte layer, is formed as the electron conduction layer by using an electrolytic plating method.

8. The method of manufacturing an electrode composite body according to claim 6,
wherein in the formation of the second composite body, a carbon-containing coat layer, which covers a part of both the active material molded body and the solid electrolyte layer, is formed as the electron conduction layer by using a sol-gel method.

9. A battery, comprising:
the electrode composite body according to claim 5; and
a second current collector that is joined to a surface of the electrode composite body from which the solid electrolyte layer is exposed alone.
